(19) United States
(12) Patent Application Publication
(10) Pub. No.: US 2012/0172273 A1
(43) Pub. Date: Jul. 5, 2012

(54) WAFER WASHING WATER AND WAFER WASHING METHOD

(75) Inventors: Tetsuo Mizuniwa, Shinjuku-ku (JP); Shigeyuki Hoshi, Tokyo (JP)

(73) Assignee: KURITA WATER INDUSTRIES LTD., Tokyo (JP)

(21) Appl. No.: 13/496,366

(22) PCT Filed: Sep. 28, 2010
(86) PCT No.: PCT/JP2010/066796

§ 371 Date: Mar. 15, 2012

(30) Foreign Application Priority Data
Oct. 5, 2009 (JP) 2009-231650

(51) Int. Cl. C11D 7/60

(52) U.S. Cl. 510/175

(57) ABSTRACT

The invention provides a wafer washing technique which does not require complicated operations and by which a wafer is washed with ultrapure water through relatively simple operations without contaminating the wafer surface with metals even if the ultrapure water contains metal ions on the ng/L (ppt) level. Wafer washing water includes ultrapure water to which a substance having an affinity for metal ions has been added. A wafer washing method uses this wafer washing water. A substance that exhibits an affinity for metal ions is added beforehand to wafer washing ultrapure water. As a result, the substance captures metal ions present in the ultrapure water and stabilizes them in water, thereby effectively preventing the metal ions from migrating toward the wafer surface and becoming attached to the wafer surface during washing.

### FIELD OF INVENTION

The present invention relates to wafer washing water and a wafer washing method. In particular, the invention relates to wafer washing water based on ultrapure water that is used in order to rinse a silicon wafer for semiconductor production and does not contaminate the wafer surface with metals even if the ultrapure water contains metal ions on the ng/L (ppt) level. The invention also relates to a wafer washing method using this wafer washing water.

### BACKGROUND ART

Washing a silicon wafer substrate in semiconductor production includes cleaning the wafer with various chemicals and thereafter rinsing it with ultrapure water in order to remove the chemicals. Because ultrapure water used in the rinsing directly contacts the wafer surface, the amount of impurities in the ultrapure water is reduced as much as possible in order to achieve a highly clean wafer surface.

Recent refinement of LSI and progress in analytical technology have made possible high-sensitivity measurement of the concentration of impurities in ultrapure water and the concentration of impurities on the wafer surface. For example, the presence of metals such as calcium and iron in ultrapure water can be detected even when the concentration is as low as 1 ng/L (ppt). According to a recent technique, even wafers that have been washed with ultrapure water having an extremely low concentration of metal impurities are found to be contaminated with metals such as calcium and iron on the surface in an amount exceeding 10⁹ atoms per 1 cm² of wafer surface (10⁹ atom/cm²).

Even when the amount of metals contained in wafer washing ultrapure water is fairly small, the surface of a wafer washed with such ultrapure water becomes contaminated with the metals. Actually, the present inventors have examined the relation between the concentration of metals such as calcium, iron, zinc and aluminum in ultrapure water and the concentration of such metals on the silicon wafer surface that has been contacted with the ultrapure water. The results have shown that the presence of metals at about 1 ng/L (1 ppt) in ultrapure water causes an increase of about 1×10¹⁰ to 5×10¹⁰ atom/cm² in terms of metal concentration on the silicon wafer surface that has been in contact with the ultrapure water.

Thus, even when ultrapure water has been highly purified, the direct use of such ultrapure water in washing of a silicon wafer results in a contamination of the wafer surface with metals present in the water. Such contaminants can adversely affect the performance of electronic circuits which will be formed on the wafer surface.

The presence of these trace metals on a wafer is of greater concern as semiconductors become finer. Thus, there has been a need for a washing technique that does not contaminate the wafer surface.

A conventional method for removing impurity metal ions on a semiconductor wafer uses washing water which is formed by dissolving a gas such as ozone in pure water (for example, Japanese Unexamined Patent Application Publication No. 2000-098320). In order to control the concentration of dissolved gas to a desired value, this method requires complicated operations such as removing any gas dissolved in pure water and thereafter dissolving a desired gas so as to control the concentration of dissolved gas. Thus, this method necessitates various efforts as well as labor and time in order to maintain the concentration of dissolved gas to a desired concentration at a place where the washing water is used.

### LIST OF DOCUMENT

### Patent Document

Patent Document 1: Japanese Patent Publication 2000-098320 A

### OBJECT AND SUMMARY OF INVENTION

### Object of Invention

The present invention has been made in view of the problems in the art described above. It is therefore an object of the invention to provide a wafer washing technique which does not require complicated operations and by which a wafer is washed with ultrapure water through relatively simple operations without contaminating the wafer surface with metals even if the ultrapure water contains metal ions on the ng/L (ppt) level.

### SUMMARY OF INVENTION

A first embodiment of the present invention is directed to wafer washing water that includes ultrapure water to which a substance having an affinity for metal ions has been added.

A second embodiment is directed to the wafer washing water according to the first embodiment, wherein the substance having an affinity for metal ions is a hydrophilic organic substance and the organic substance is capable of bonding to metal ions in water.

A third embodiment is directed to the wafer washing water according to the second embodiment, wherein the hydrophilic organic substance is polystyrenesulfonic acid and/or a derivative thereof.

A fourth embodiment is directed to a wafer washing method for cleaning the surface of a silicon wafer, in which washing water used for the washing is the wafer washing water described in any one of the first to third embodiments.

### ADVANTAGEOUS EFFECTS OF INVENTION

According to the present invention, a substance that exhibits an affinity for metal ions is added beforehand to wafer washing ultrapure water. As a result, the substance captures metal ions present in the ultrapure water and stabilizes them in water, thereby effectively preventing the metal ions from migrating toward the wafer surface and becoming attached to the wafer surface during washing (the first to fourth embodiments).

The substance having an affinity for metal ions is preferably a hydrophilic organic substance that is capable of bonding to metal ions in water (the second embodiment). In particular, the hydrophilic organic substance is preferably polystyrenesulfonic acid and/or a derivative thereof (the third embodiment).

According to the inventive wafer washing method using the wafer washing water of the invention, wafers that are free of metal contamination can be manufactured even if metals are detected in ultrapure water produced with an ultrapure water production apparatus. Thus, the invention eliminates the need for ultrapure water to be unduly highly treated in an ultrapure water production apparatus, thereby reducing the costs of the production of ultrapure water.

When an ultrapure water production apparatus which can produce ultrapure water of high purity is newly constructed or maintained, there is a risk that the purity of ultrapure water be slightly changed. The present invention may be applied to such cases. Namely, the operations can be continued without causing variations in the amount of metals attached to a wafer by previously adding a small amount of polystyrenesulfonic acid and/or a derivative thereof to the ultrapure water, thereby contributing to stable plant operations.

### BRIEF DESCRIPTION OF DRAWING

FIG. 1 is a flow diagram of a wafer washing experimental apparatus used in EXAMPLES.

### DESCRIPTION OF EMBODIMENTS

In the course of studies toward the aforementioned object, the present inventors focused on the fact that the contamination of a wafer surface with metal ions contained in ultrapure water, which is a wafer washing medium, is the result of the migration and attachment of the metal ions in the water to the wafer surface. In order to prevent this phenomenon, the present authors devised the following two approaches.

1) An approach where a substance other than metals is attached in advance to regions on the wafer surface where metals may possibly attach, thereby preventing the attachment of metals.

2) An approach where metal ions contained in ultrapure water are stabilized so as to allow them to be stably present in water and prevent them from becoming attached to the wafer surface.

Of these approaches, the approach 1) is not appropriate from the viewpoint of cleaning of the wafer surface because a substance of a different kind is attached or adsorbed on a wafer which is to be cleaned. On the other hand, the approach 2) is a viable method.

In order to realize the method 2), the present inventors have developed a technique in which a substance capable of bonding to metal ions such as calcium and iron ions while staying dissolved stably in water is added to water so as to stabilize such metal ions in the water in the form of a compound or complex instead of in the form of metal ions.

The present invention has been completed on the basis of this finding.

Embodiments of wafer washing water and a wafer washing method according to the present invention will be described in detail hereinbelow.

The wafer washing water of the invention is based on ultrapure water to which a substance having an affinity for metal ions (hereinafter, sometimes referred to as “metal affinity substance”) has been added. In the wafer washing method of the invention, a wafer is washed using this wafer washing water.

In the invention, the metal affinity substance is preferably a hydrophilic organic substance capable of bonding to metal ions in water. That is, in order to stabilize metal ions such as calcium and iron ions in water, the substance needs to be capable of bonding to these metal ions while staying dissolved stably in water so as to stabilize such metals in the water in the form of a compound or complex instead of in the form of metal ions. For this purpose, a hydrophilic organic substance capable of bonding to metal ions in water is a preferred metal affinity substance. In order for the organic substance to effectively bond to metal ions and stabilize them stably in water while the addition of organic substance is such that the concentration thereof is as low as possible, it is preferable that the organic substance have functional groups capable of bonding to metal ions which are as acidic as possible.

General acidic functional groups capable of bonding to metal ions are described below. Of these functional groups, the sulfonic group is the most acidic and is therefore considered to be a good metal capturing agent.

Sulfonic group: apparent pK<1

Carboxyl group: apparent pK=4-6

Phosphoric group: apparent pK₁=2-3, pK₂=7-8

### (Source: “DIA ION MANUAL II” p. 21, Mitsubishi Chemical Corporation).

Accordingly, a substance having a sulfonic group can produce an effect with the smallest amount of substance and is therefore preferable as the substance having an acidic functional group that is added in order to capture metal ions in water and stabilize them in water. For example, an amount in terms of TOC of an organic compound having a sulfonic group that is as small as 10 μg/L (ppb) or less enables a high level of cleaning of the wafer surface without metal contamination even if the washing ultrapure water contains metal ions such as calcium, iron and zinc ions. The metal affinity substance may be a chelating agent such as ethylene diamine tetraacetic acid (EDTA) or an organic acid such as oxalic acid or citric acid.

In order for the metal affinity substance to be stably present in water while being bonded to metal ions, the substance is preferably a highly hydrophilic compound. Polystyrenesulfonic acid is a substance that is used in order to introduce exchange groups into a cation exchange resin. This compound exhibits a high bond strength with respect to metals and is hydrophilic. Therefore, this compound can strongly capture metal ions and be present stably in water. Accordingly, polystyrenesulfonic acid or a derivative thereof is a preferred substance for preventing metal ions in water from becoming attached to the wafer surface to cause contamination. However, the molecules which have an acidic group such as the sulfonic group are not limited to polystyrene, and any hydrophilic substances may be used.

Polystyrenesulfonic acid that is suitably used as the metal affinity substance in the invention preferably has a weight average molecular weight of about 100 to 5,000, and particularly preferably about 200 to 1,000. Polystyrenesulfonic acid having an excessively large molecular weight can become attached to a solid surface to cause contamination.

Examples of the polystyrenesulfonic acid derivatives include sodium salt and potassium salt of such a polystyrenesulfonic acid as described above.

The metal affinity substances may be used singly, or two or more may be used in combination.

The amount of metal affinity substance that is added to ultrapure water may vary in accordance with the metal ion concentration in ultrapure water or the kind of the used metal affinity substance, and is not limited to any particular amount. In the case of a hydrophilic organic substance having an acidic group such as a sulfonic group, for example polystyrenesulfonic acid and/or a derivative thereof, a wafer may be cleaned to a high degree of cleanliness while preventing the attachment of metals to the wafer as well as the contamination with residual metals by adding such a substance in an amount in terms of a TOC concentration of 10 μg/L (ppb) or less, for example about 1 to 10 μg/L, in particular about 1 to 5 μg/L (ppb) to ultrapure water containing about 0.1 to 10 ng/L (ppt) of metal ions such as calcium, iron and zinc ions.

Adding the metal affinity substance in an excessively small amount does not produce the advantageous effects according to the invention obtained by adding the metal affinity substance. An excessively large amount is not preferable because wafer contamination can be caused depending on the kind of metal affinity substance that is used.

The ultrapure water that is used in the washing according to the present invention is high-purity ultrapure water that is commonly used in a final rinsing stage in a general wafer washing process. The metal ion concentration in the ultrapure water is generally not more than 10 ng/L (ppt), for example about 1 to 5 ng/L (ppt).

The inventive wafer washing method performs washing with the wafer washing water which is formed by adding the aforementioned metal affinity substance to such ultrapure water as described above. The wafer washing method is not particularly limited, and soak washing, spray washing or the like may be carried out in accordance with common procedures.

According to the invention, a wafer is washed with ultrapure water to which the metal affinity substance has been added. Without the need for the ultrapure water to be highly purified so as to achieve a high level of removal of metals, such a simple operation as adding a predetermined amount of metal affinity substance to ultrapure water can prevent metal ions in the ultrapure water from becoming attached to the wafer surface. In this manner, a clean wafer can be obtained which can cope with recent refinement of LSI, with the metal concentration on the wafer surface being not more than 10⁹ atom/cm². In addition, the inventive technique reduces the number of treatment steps performed in the production of ultrapure water and reduces the costs for the production of ultrapure water.

### EXAMPLES

The present invention will be described in greater detail by presenting EXAMPLES and COMPARATIVE EXAMPLES below.

### Examples 1 and 2

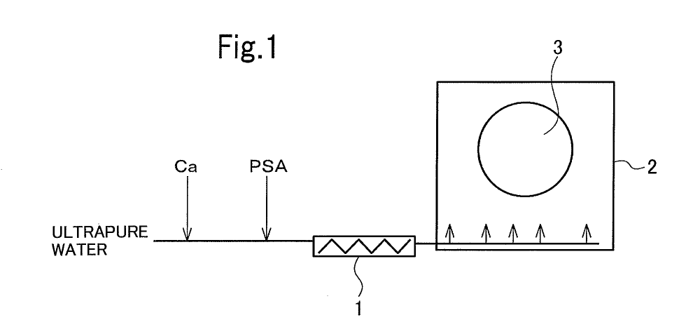

With a washing experimental apparatus illustrated in FIG. 1, calcium chloride was added to ultrapure water at a Ca concentration of 2.4 ppt (EXAMPLE 1) or 1.9 ppt (EXAMPLE 2) and thereafter PSA (polystyrenesulfonic acid, weight average molecular weight: 720) was added at a concentration of 2 μg-C/L. These were mixed together with a line mixer 1. The resultant wafer washing water which was formed of ultrapure water containing Ca and PSA was supplied to a quartz-made washing tank 2, and a silicon wafer 3 was washed.

The ultrapure water used herein had a metal concentration of not more than 0.5 ng/L (ppt) with respect to each metal element. To this ultrapure water, calcium chloride was added so that the concentration of Ca in the wafer washing water after the addition of calcium chloride would be a concentration described in Table 1. The metal ion concentration in the wafer washing water was measured by an ICP-MS method. In EXAMPLES 1 and 2, PSA was added so that the TOC concentration in the wafer washing water would be 2 μg/L (ppb) (addition amount: 2 μg-C/L).

In EXAMPLES 1 and 2, a silicon wafer 3 (6 inches in diameter, crystal orientation (100), doped p-type) was washed by being soaked in the wafer washing water for 10 minutes while supplying the wafer washing water to the washing tank 2 at a supply rate of 1 L/min. After being washed, the wafer was lifted from the water and was allowed to stand to dry. The dried wafer was treated with hydrofluoric acid vapor in order to decompose the surface oxide layer, and the surface was scanned with droplets of a diluted hydrofluoric acid solution so as to recover metals. The droplets were dried on the wafer surface. The dried trace was analyzed with a total reflection X-ray fluorescence analyzer to determine the Ca concentration. Based on the concentration rate which had been determined separately, the Ca concentration on the surface of the tested wafer was calculated. Two wafers were washed, and the average Ca concentration on the two wafers was obtained. The results are described in Table 1.

### Comparative Examples 1 to 4

Silicon wafers were washed in the same manner as in EXAMPLES 1 and 2, except that Ca was added to ultrapure water in such an amount that the Ca concentration would be a value shown in Table 1, and that the polystyrenesulfonic acid was not added to the ultrapure water. The Ca concentration on the surface was measured. The results are described in Table 1.

TABLE 1

| | | Addition | |
|---|---|---|---|
| | Ca concentration | amount of | |
| | in wafer | polystyrene- | Ca concentration |
| | washing water | sulfonic acid | on wafer surface |
| | (ng/L (ppt)) | (μg-C/L) | (×10¹⁰atom/cm²) |
| EXAMPLE 1 | 2.4 | 2 | 0.2 |
| EXAMPLE 2 | 1.9 | 2 | <0.1 |
| COMPARATIVE | 2.5 | Not added | 3.3 |
| EXAMPLE 1 | | | |
| COMPARATIVE | 2.5 | Not added | 3.2 |
| EXAMPLE 2 | | | |
| COMPARATIVE | 2.0 | Not added | 3.5 |
| EXAMPLE 3 | | | |
| COMPARATIVE | 1.6 | Not added | 2.9 |
| EXAMPLE 4 | | | |

The results in Table 1 show the following.

In COMPARATIVE EXAMPLES 1 to 4, silicon wafers were washed with the wafer washing water containing Ca at about 1.5 to 2.5 ng/L (ppt) and no PSA. The Ca concentration on the surface of the washed wafer was in the range of about 3 to 3.5×10¹⁰ atom/cm². Thus, calcium was confirmed to have become attached to the wafer during the soak washing. In contrast, EXAMPLES 1 and 2 in which the wafer washing water contained PSA at a concentration in terms of TOC of 2 μg/L (ppb) resulted in an amount of Ca attached to the wafer of not more than 2×10⁹ atom/cm². In comparison with COMPARATIVE EXAMPLES 1 to 4 in which PSA was not added, the attachment of Ca was markedly prevented.

Although the present invention has been described in detail based on specific embodiments, the person skilled in the art will understand that various modifications are possible within the spirit and the scope of the present invention.

The present application is based on a Japanese patent application filed in the Japanese Patent Office on Oct. 5, 2009 (Japanese Patent Application No. 2009-231650), the entire contents of which are incorporated herein by reference.

1. Wafer washing water that comprises ultrapure water to which a substance having an affinity for metal ions has been added.

2. The wafer washing water according to claim 1, wherein the substance having an affinity for metal ions is a hydrophilic organic substance and the organic substance is capable of bonding to metal ions in water.

3. The wafer washing water according to claim 2, wherein the hydrophilic organic substance is polystyrenesulfonic acid and/or a derivative thereof.

4. The wafer washing water according to claim 2, wherein the hydrophilic organic substance is polystyrenesulfonic acid.

5. The wafer washing water according to claim 4, wherein the polystyrenesulfonic acid has a weight average molecular weight of 100 to 5000.

6. The wafer washing water according to claim 5, wherein the concentration of polystyrenesulfonic acid in terms of a TOC concentration is 1 to 10 μg/L.

7. A wafer washing method comprising washing a silicon wafer with the wafer washing water described in claim 1.
